(19) United States
(12) Patent Application Publication
(10) Pub. No.: US 2018/0107133 A1
(43) Pub. Date: Apr. 19, 2018

(54) IMAGE FORMING APPARATUS AND DEVELOPING DEVICE

(71) Applicant: Oki Data Corporation, Tokyo (JP)

(72) Inventor: Yuichi FURUKAWA, Tokyo (JP)

(73) Assignee: Oki Data Corporation, Tokyo (JP)

(21) Appl. No.: 15/787,245

(22) Filed: Oct. 18, 2017

(30) Foreign Application Priority Data
Oct. 19, 2016 (JP) 2016-205108

(51) Int. Cl. G03G 9/00

(52) U.S. Cl. CPC G03G 15/0189; G03G 15/2064; G03G 15/0131; G03G 15/04; G03G 15/0808

(57) ABSTRACT

An image forming apparatus includes a developer, an image bearing body, a charging member that charges a surface of the image bearing body, an exposure device that emits light to expose the surface of the image bearing body to form a latent image, a developer bearing body that bears the developer and develops the latent image to form a developer image, and a transfer portion that transfers the developer image from the image bearing body to a transfer body. The developer includes mother particles containing crystalline polyester resin as a binder resin, and a plurality of kinds of external additives containing silica and having different particle diameters. A value obtained by dividing a flowability of the developer by a weight percent of silica contained in the developer is in a range from 8.6 to 11.4. The weight percent of silica is measured by an energy dispersion type X-ray analyzer.

### BACKGROUND OF THE INVENTION

The present invention relates to an image forming apparatus and a developing device using an electrophotographic method.

In an image forming apparatus such as a printer, a copier, a facsimile machine or the like using an electrophotographic method, an electrostatic latent image is formed on a surface of a photosensitive drum (i.e., an image bearing body) by exposure. The latent image is developed with a toner (i.e., a developer), and a toner image is famed. The toner image is transferred to a recording medium, and is fixed to the recording medium by application of heat and pressure.

In order to reduce energy consumption of the image forming apparatus, it is necessary to lower a fixing temperature of the toner. For this reason, it is desired to lower a melting point of the toner.

Generally, a toner includes toner mother particles and an external additive covering the toner mother particles as disclosed in, for example, Japanese Application Publication No. 2014-139665 (paragraphs 0038-0043). A low melt toner (i.e., a low melting point toner) includes a larger amount of external additive covering the toner mother particles in order that the toner does not melt except in the fixing process.

When the amount of the external additive covering the toner mother particles increases, a part of the external additive is likely to separate from the toner mother particles. If such external additive adheres to the surface of the photosensitive drum, the external additive may block light incident on the photosensitive drum, and may affect printing quality.

It is conceivable to increase a particle diameter of the external additive in order to facilitate removing the external additive using a cleaning member contacting the photosensitive drum. However, when the particle diameter of the external additive increases, a flowability of the toner may be lowered. In such a case, the toner may adhere to a non-image portion (i.e., a portion other than a latent image) on the surface of the photosensitive drum, and may cause image defects such as smear.

### SUMMARY OF THE INVENTION

An embodiment of the present invention is intended to provide an image forming apparatus and a developing device capable of forming an image of high quality even when a low melt developer is used.

According to an aspect of the present invention, there is provided an image forming apparatus including a developer, an image bearing body, a charging member that charges a surface of the image bearing body, an exposure device that emits light to expose the surface of the image bearing body to form a latent image, a developer bearing body that bears the developer and develops the latent image to form a developer image, and a transfer portion that transfers the developer image from the image bearing body to a transfer body. The developer includes mother particles containing crystalline polyester resin as a binder resin, and a plurality of kinds of external additives containing silica and having different particle diameters. A value obtained by dividing a flowability of the developer by a weight percent of silica contained in the developer is in a range from 8.6 to 11.4. The weight percent of silica is measured by an energy dispersion type X-ray analyzer.

According to another aspect of the present invention, there is provided a developing device including a developer, and a developer bearing body that bears the developer and develops a latent image famed on an image bearing body. The developer includes mother particles containing crystalline polyester resin as a binder resin, and a plurality of kinds of external additives containing silica and having different particle diameters. A value obtained by dividing a flowability of the developer by a weight percent of silica contained in the developer is in a range from 8.6 to 11.4. The weight percent of silica is measured by an energy dispersion type X-ray analyzer.

With such a configuration, it becomes possible to form an image of high quality even when a low melt developer is used.

### BRIEF DESCRIPTION OF THE DRAWINGS

In the attached drawings:

FIG. 1 is a schematic sectional view showing a configuration of an image forming apparatus of the embodiment of the present invention;

FIG. 2 is a schematic view showing a configuration of a process unit of the embodiment;

FIG. 3 is a block diagram showing a control system of the image forming apparatus of the embodiment;

FIG. 4 is a schematic view illustrating an influence of an external additive separated from toner mother particles;

FIG. 5A is a schematic view showing a printed image where no periodic residual image appears;

FIG. 5B is a schematic view showing a printed image where a periodic residual image appears;

FIG. 6 is a schematic view illustrating a collecting method of the external additive on a photosensitive drum;

FIG. 7 is a table showing an amount of the external additive on the photosensitive drum and an evaluation result of the periodic residual image;

FIG. 8 is a graph showing the amount of the external additive on the photosensitive drum and the evaluation result of the periodic residual image;

FIG. 9 is a table showing a ratio of silica P1-P4 contained in a toner, an amount of Si contained in the toner, the amount of the external additive on the photosensitive drum, the evaluation result of the periodic residual image, a flowability, and a flowability contribution for samples 1-8; and

FIG. 10 is a table showing the ratio of silica P1-P4 contained in the toner, the amount of Si contained in the toner, the evaluation result of the periodic residual image, the flowability, the flowability contribution, and an evaluation result of smear for samples 1-11.

### DETAILED DESCRIPTION OF THE PREFERRED EMBODIMENT

### <Configuration of Image Forming Apparatus>

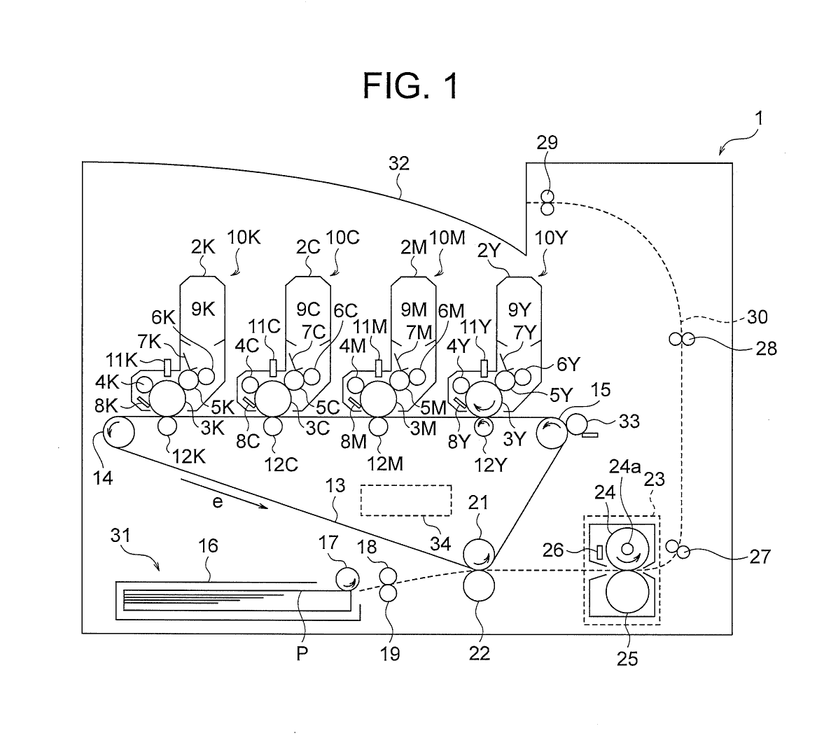

FIG. 1 shows a configuration of an image forming apparatus 1 according to an embodiment of the present invention. The image forming apparatus 1 is, for example, a color printer, and prints a toner image (i.e., a developer image) on a recording medium P using an electrophotographic method.

The image forming apparatus 1 includes process units 2Y, 2M, 2C and 2K as image forming units, LED heads 11Y, 11M, 11C and 11K as exposure units (i.e., exposure devices), an intermediate transfer belt 13 as a transfer body (i.e., an intermediate transfer body), primary transfer rollers 12Y, 12M, 12C and 12K as transfer portions (i.e., primary transfer portions), a secondary transfer roller 22 and a secondary transfer backup roller 21 as a secondary transfer portion, and a fixing device 23.

The process units 2Y, 2M, 2C and 2K are configured to form toner images of yellow (Y), magenta (M), cyan (C) and black (K). The process units 2Y, 2M, 2C and 2K are arranged in this order from right to left in FIG. 1 along a moving direction of the intermediate transfer belt 13. In this regard, an arrangement order of the process units is not limited to the above described example, but the process units may be arranged in any order. Further, the number of process units is not limited to four, but may be three or less, or five or more.

The process units 2Y, 2M, 2C and 2K include photosensitive drums 3Y, 3M, 3C and 3K as image bearing bodies, charging rollers 4Y, 4M, 4C and 4K as charging members, developing rollers 5Y, 5M, 5C and 5K as developer bearing bodies, and the supplying rollers 6Y, 6M, 6C and 6K as developer supplying members, regulation blades 7Y, 7M, 7C and 7K as developer regulation members, cleaning blades 8Y, 8M, 8C and 8K as cleaning members, and toner cartridges 9Y, 9M, 9C and 9K as developer storage bodies.

Configurations of the process units 2Y, 2M, 2C and 2K will be described. The process units 2Y, 2M, 2C and 2K has the same configuration except for toners, and therefore the process units 2Y, 2M, 2C and 2K are collectively referred to as the process unit 2. Further, the photosensitive drums 3Y, 3M, 3C and 3K are collectively referred to as the photosensitive drum 3. The charging rollers 4Y, 4M, 4C and 4K are collectively referred to as the charging roller 4. The developing rollers 5Y, 5M, 5C and 5K are collectively referred to as the developing roller 5. The supplying rollers 6Y, 6M, 6C and 6K are collectively referred to as the supplying roller 6. The regulation blades 7Y, 7M, 7C and 7K are collectively referred to as the regulation blade 7. The cleaning blades 8Y, 8M, 8C and 8K are collectively referred to as the cleaning blade 8. The toner cartridges 9Y, 9M, 9C and 9K are collectively referred to as the toner cartridge 9. Similarly, the LED heads 11Y, 11M, 11C and 11K are collectively referred to as the LED head 11. The primary transfer rollers 12Y, 12M, 12C and 12K are collectively referred to as the primary transfer roller 12.

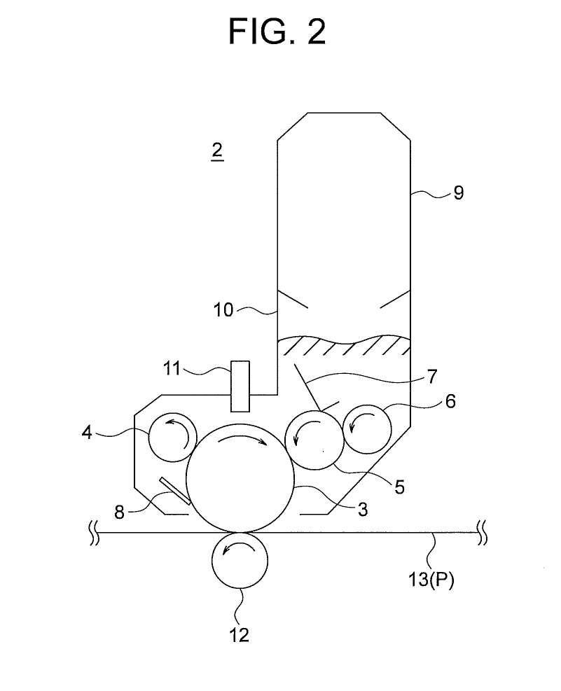

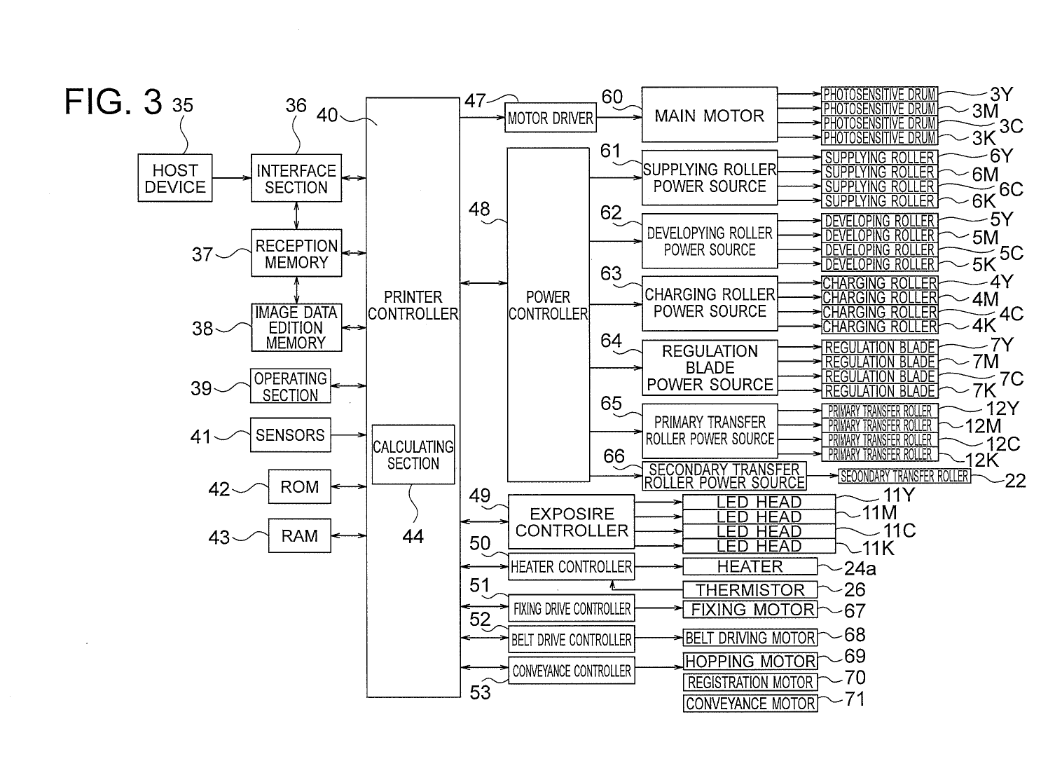

FIG. 2 is a schematic view showing a configuration of the process unit 2. The photosensitive drum 3 is formed of an organic photosensitive body. The photosensitive drum 3 includes a conductive support body having a cylindrical shape, and a photoconductive layer formed on a surface (i.e., outer circumferential surface) of the conductive support body. The conductive support body is formed of an aluminum pipe. The photoconductive layer includes a laminate of a charge generation layer and a charge transport layer. The photosensitive drum 3 is driven to rotate in one direction (clockwise in FIG. 1) by a driving force of a main motor 60 (FIG. 3). Further, the photosensitive drum 3 has an outer diameter of 30 mm. A drum part of the photosensitive drum 3 (i.e., except for a shaft portion) has a length of 322 mm in an axial direction.

The charging roller 4 is disposed so as to contact a surface of the photosensitive drum 3, and rotates following a rotation of the photosensitive drum 3. The charging roller 4 is applied with a charging voltage by a charging roller power source 63 (FIG. 3), and uniformly charges the surface of the photosensitive drum 3.

The charging roller 4 includes a conductive shaft and a conductive resilient layer formed on a surface of the conductive shaft. The conductive resilient layer is formed of an ion-conductive rubber containing epichlorohydrin rubber (ECO) as a main component. A surface of the conductive resilient layer is subjected to a surface hardening using a processing liquid containing isocyanate (HDI). The surface hardening allows for preventing chemical reaction with the photosensitive drum 3 (resulting in contamination of the photosensitive drum 3) and enhancing releasability of the toner and an external additive.

The developing roller 5 is disposed so as to contact the surface of the photosensitive drum 3. The developing roller 5 is driven to rotate by a rotation force transmitted from the photosensitive drum 3 via gears. The developing roller 5 is applied with a developing voltage by a developing roller power source 62 (FIG. 3). The developing roller 5 bears the toner on a surface thereof, and develops an electrostatic latent image on the photosensitive drum 3.

The developing roller 5 includes a conductive shaft and a resilient layer of semiconductive urethane rubber formed on a surface of the conductive shaft. A conductivity-imparting agent is dispersed in the resilient layer. The conductivity-imparting agent is, for example, an electronic conductive agent such as carbon black or conductive filler, or an ionic conductive agent. An Asker-C hardness of the resilient layer measured using an Asker-C hardness tester (manufactured by Kobunshi Keiki Co., Ltd.) is 77°. The resilient layer has a partial resistance of 20 MΩ, and an outer diameter of 19.6 mm.

In this regard, the partial resistance of the resilient layer of the developing roller 5 is measured as follows. Ball bearings each having an outer diameter of 6 mm and a width of 1.5 mm are disposed at 6 positions at equal intervals in an axial direction of the developing roller 5. Each ball bearing is pressed against a surface of the developing roller 5 by a force of 20.0 gf, and a direct voltage of −100V is applied between the conductive shaft and the ball bearing. An average of resistance values measured at the 6 positions gives the partial resistance of the resilient layer.

The supplying roller 6 is disposed so as to contact the surface of the developing roller 5. The supplying roller 6 is driven to rotate by a rotation force transmitted from the developing roller 5. The supplying roller 6 is applied with a supplying voltage by a supplying roller power source 61 (FIG. 3), and supplies the toner to the surface of the developing roller 5. The supplying roller 6 also has a function to collect the toner (which has not been transferred to the photosensitive drum 3) from the developing roller 5.

The supplying roller 6 includes a conductive shaft and a resilient layer of semiconductive foam silicone rubber formed on a surface of the conductive shaft. An Asker-F hardness of the resilient layer measured using an Asker-F hardness tester (manufactured by Kobunshi Keiki Co., Ltd.) is 57°. The resilient layer has a partial resistance of 30 MΩ, and is polished to an outer diameter of 15.6 mm. The silicone rubber of the resilient layer may be formed of various kinds of synthetic rubber such as dimethyl silicone rubber, methyl-phenyl silicone rubber or the like, and a reinforcing silica filler, a vulcanizing agent (needed for vulcanization) and a foaming agent may be added to the synthetic rubber.

The regulation blade 7 is a metal blade elongated in an axial direction of the developing roller 5. The regulation blade 7 is disposed so as to contact a surface of the developing roller 5. The regulation blade 7 is applied with a blade voltage by a regulation blade power source 64 (FIG. 3), and regulates a thickness of a toner layer (i.e., a developer layer) formed on the surface of the developing roller 5.

The regulation blade 7 is formed of, for example, a stainless steel (SUS). A thickness (i.e., a plate thickness) of the regulation blade 7 is 0.08 mm. The regulation blade 7 has a bent portion contacting the developing roller 5. The bent portion has a radius of curvature of 0.18 mm, and a roughness (i.e., a ten-point average roughness) Rz of is 0.6 μm.

The cleaning blade 8 is disposed so as to face a surface of the photosensitive drum 3, and scrapes off (i.e., removes) the toner remaining on the surface of the photosensitive drum 3 after a primary transfer of a toner image.

The toner cartridge 9 is a detachably mounted container, and stores the toner of the corresponding color. The toner cartridge 9 supplies the toner to the developing roller 5 and the supplying roller 6.

The LED head 11 includes a light emitting element array in which a plurality of LED elements (i.e., light emitting elements) are arranged, and a lens array in which a plurality of microlenses are arranged. The LED head 11 is disposed at a position at which light emitted by the LED element is focused on the surface of the photosensitive drum 3. The LED head 11 emits light based on image data inputted from an exposure controller 49 (FIG. 3) to expose the surface of the photosensitive drum 3, and forms a latent image (i.e., an electrostatic latent image).

In the process unit 2, a section that develops a latent image on the photosensitive drum 3 with toner (i.e., a section including the developing roller 5, the supplying roller 6, the regulation blade 7 and the toner cartridge 9) is referred to as a developing device 10. The developing device 10 (for example, a drum-integrated-type developing device) may also include the photosensitive drum 3 and the charging roller 4. In FIG. 1, the process units 2Y, 2M, 2C and 2K respectively include developing devices 10Y, 10M, 10C and 10K.

As shown in FIG. 1, the intermediate transfer belt 13 is an endless (i.e., seamless) belt, and is formed of a plastic film having a high electric resistance. The intermediate transfer belt 13 is wound around a belt driving roller 14, a driven roller 15 and the secondary transfer backup roller 21.

The belt driving roller 14 is driven to rotate by a driving force of a belt driving motor 68 (FIG. 3), and causes the intermediate transfer belt 13 to move in a direction shown by an arrow “e” in FIG. 1. The driven roller 15 applies a certain tension to the intermediate transfer belt 13, and rotates following the movement of the intermediate transfer belt 13. The secondary transfer backup roller 21 and the secondary transfer roller 22 (described later) constitute the secondary transfer portion.

An intermediate transfer belt cleaning member 33 is disposed so as to contact a surface (i.e., an outer circumferential surface) of the intermediate transfer belt 13. The intermediate transfer belt cleaning member 33 removes the toner remaining on the intermediate transfer belt 13 (i.e., having not being transferred at the secondary transfer portion). A waste toner removed by the intermediate transfer belt cleaning member 33 is conveyed through a not shown waste toner conveying path, and is recovered by a waste toner recovery section 34.

The primary transfer rollers 12Y, 12M, 12C and 12K are disposed so as to contact the photosensitive drums 3Y, 3M, 3C and 3K via the intermediate transfer belt 13, and constitute primary transfer portions. Primary transfer nips are respectively formed between the primary transfer rollers 12Y, 12M, 12C and 12K and the photosensitive drums 3Y, 3M, 3C and 3K.

Each of the primary transfer rollers 12Y, 12M, 12C and 12K is applied with a primary transfer voltage by a primary transfer roller power source 65 (FIG. 3). With the primary transfer voltage, the toner images on the surfaces of the photosensitive drums 3Y, 3M, 3C and 3K are transferred to the surface of the intermediate transfer belt 13.

The image forming apparatus 1 has a conveyance path 30 (shown by a dashed line in FIG. 1) along which the recording media P such as a printing sheet is conveyed. A feeding mechanism 31 is provided at a lower part of the image forming apparatus 1. The feeding mechanism is configured to feed the recording medium P to the conveyance path 30.

The feeding mechanism 31 includes a medium cassette 16 as a medium storage portion, a hopping roller 17, a registration roller 18 and a pinch roller 19. The medium cassette 16 stores a stack of the recording medium P (for example, printing sheets). The hopping roller 17 is driven to rotate by a driving force of a hopping motor 69 (FIG. 3), and feeds the recording media P from the medium cassette 16 one by one. The registration roller 18 and the pinch roller 19 form a nip portion therebetween. The registration roller 18 is driven to rotate by a driving force of a registration motor 70 (FIG. 3). The registration roller 18 starts rotation at a predetermined timing after a tip of the recording medium P abuts against the nip portion, so as to correct a skew of the recording medium P and convey the recording medium P toward the secondary transfer portion.

In a conveying direction of the recording medium P (hereinafter referred to as a medium conveying direction), the secondary transfer roller 22 and the secondary transfer backup roller 21 (constituting the secondary transfer portion) are disposed downstream of the feeding mechanism 31. The secondary transfer roller 22 and the secondary transfer backup roller 21 are disposed so as to sandwich the intermediate transfer belt 13 therebetween.

A secondary transfer nip is formed between the secondary transfer roller 22 and the secondary transfer backup roller 21. The recording medium P conveyed from the feeding mechanism 31 is introduced into the secondary transfer nip. The secondary transfer roller 22 is applied with a secondary transfer voltage by a secondary transfer roller power source 66 (FIG. 3). With the secondary transfer voltage, the toner image on the surface of the intermediate transfer belt 13 is transferred to the recording medium P fed from the feeding mechanism 31.

The fixing device 23 is disposed downstream of the secondary transfer portion in the medium conveying direction. The fixing device 23 applies heat and pressure to the toner (having been transferred thereto in the secondary transfer portion), and causes the toner to be molten and fixed to the recording medium P. The fixing device 23 includes a heat roller 24, a pressure roller 25 and a thermistor 26.

The heat roller 24 is driven to rotate by a driving force of a fixing motor 67 (FIG. 3). The pressure roller 25 rotates following the rotation of the heat roller 24. The heat roller 24 has a heater 24a (for example, a halogen lamp) as a heat source. The heater 24a is controlled by a heater controller 50 (FIG. 3). The thermistor 26 is disposed in the vicinity of a surface of the heat roller 24, and detects a temperature of the heat roller 24.

Conveying roller pairs 27, 28 and 29 are disposed downstream of the fixing device 23 in the medium conveying direction. The conveying roller pairs 27, 28 and 29 are configured to convey the recording medium P to a stacker portion 32. The conveying roller pairs 27, 28 and 29 are driven to rotate by a conveyance motor 71 (FIG. 3). The recording medium P with the fixed toner image is conveyed by the conveying roller pairs 27, 28 and 29, is ejected outside the image forming apparatus 1, and is placed on the stacker portion 32.

### <Control System of Image Forming Apparatus>

FIG. 3 is a block diagram showing a control system of the image forming apparatus 1. The image forming apparatus 1 includes a printer controller 40, an interface section 36, a reception memory 37, an image data edition memory 38, an operating section 39, sensors 41, a ROM 42, a RAM 43, a calculating section 44, a motor driver 47, a power controller 48, an exposure controller 49, a heater controller 50, a fixing drive controller 51, a belt drive controller 52, and a conveyance controller 53.

The interface section 36 receives a command and print data from a host device 35 such as a host computer. The reception memory 37 temporarily stores the print data received from the host device 35 via the interface section 36. The image data edition memory 38 receives the print data stored in the reception memory 37, edits the print data to create an image data, and stores the image data. The operating section 39 has operation keys and the like with which an operator inputs instructions to the image forming apparatus 1, and a display for displaying a state of the image forming apparatus 1.

The sensors 41 include various sensors for detecting a state of the image forming apparatus 1. For example, the sensors 41 include a medium sensor for detecting a position of the recording medium P on the conveyance path 30, a density sensor for detecting a density of a toner image, and the like. The ROM (Read Only Memory) 42 stores various programs performed by the printer controller 40. The RAM (Random Access Memory) 43 stores various data used for image formation.

The printer controller 40 has, for example, a CPU (Central Processing Unit) and the like. The printer controller 40 receives inputs such as instructions from the reception memory 37 and signals representing a state of the image forming apparatus 1 (for example, a signal regarding a conveyance position of the recording medium P) from the sensors 41. The printer controller 40 controls the motor driver 47, the power controller 48, the exposure controller 49, the heater controller 50, the fixing drive controller 51, the belt drive controller 52, and the conveyance controller 53 based on the inputs.

The motor driver 47 controls a main motor 60 for rotating the photosensitive drums 3Y, 3M, 3C and 3K based on instructions from the printer controller 40. Other rollers of the process units 2Y, 2M, 2C and 2K rotate following the photosensitive drums 3Y, 3M, 3C and 3K, or are driven to rotate by rotation forces transferred from the photosensitive drums 3Y, 3M, 3C and 3K via gear.

The power controller 48 controls the charging voltage applied to the charging rollers 4Y, 4M, 4C and 4K from the charging roller power source 63 and the developing voltage applied to the developing rollers 5Y, 5M, 5C and 5K from the developing roller power source 62, based on instructions from the printer controller 40.

The power controller 48 also controls the supplying voltage applied to the supplying rollers 6Y, 6M, 6C and 6K from the supplying roller power source 61 and the blade voltage applied to the regulation blades 7Y, 7M, 7C and 7K from the regulation blade power source 64, based on instructions from the printer controller 40.

The power controller 48 also controls the primary transfer voltage applied to the primary transfer rollers 12Y, 12M, 12C and 12K from the primary transfer roller power source 65 and the secondary transfer voltage applied to the secondary transfer roller 22 from the secondary transfer roller power source 66, based on instructions from the printer controller 40.

In this regard, the main motor 60, the supplying roller power source 61, the developing roller power source 62, the charging roller power source 63, the regulation blade power source 64 and the primary transfer roller power source 65 are respectively illustrated as single blocks in FIG. 3. However, in a particular example, the image forming apparatus 1 includes four main motors 60, supplying roller power sources 61, developing roller power sources 62, charging roller power sources 63, regulation blade power sources 64 and primary transfer roller power sources 65 respectively.

The exposure controller 49 controls light emission of the LED heads 11Y, 11M, 11C and 11K based on instructions and image data from the printer controller 40. The heater controller 50 has a temperature adjustment circuit, and controls the heater 24a in the heat roller 24 based on a temperature detected by the thermistor 26 mounted to the fixing device 23.

The fixing drive controller 51 controls the fixing motor 67 for rotating the heat roller 24. The belt drive controller 52 controls the belt driving motor 68 for rotating the belt driving roller 14.

The conveyance controller 53 controls the hopping motor 69 for rotating the hopping roller 17, the registration motor 70 for rotating the registration roller 18, and the conveyance motor 71 for rotating the conveying roller pairs 27, 28 and 29.

### <Composition of Toner>

The toner (developer) used in this embodiment is a nonmagnetic single-component toner, and does not contain a carrier as in a two-component toner. Further, the toner used in this embodiment is a pulverized toner formed by a pulverization method, and is a low melt toner having a glass transition temperature Tg lower than or equal to 60° C. Description will be made of a composition and a manufacturing method of the toner.

The toner is obtained by adding an external additive to toner mother particles (i.e., mother particles) containing at least a binder resin. The binder resin contains crystalline polyester resin having a crystalline structure. The reason that the toner mother particles contain crystalline polyester resin (as the binder resin) is in order to lower a melt point of the toner. The binder resin of the toner mother particles further contain amorphous polyester resin of low molecular weight and amorphous polyester resin of high molecular weight, in addition to crystalline polyester resin. The reason that the toner mother particles contain amorphous polyester resin (as the binder resin) is in order to suppress decrease in durability and preservability of the toner.

In this regard, styrene acryl resin, epoxy resin, styrene butadiene resin, or a combination of any of these resin may be used as the binder resin.

A release agent and a colorant are added to the binder resin. Further, additive agents such as a charge control agent, a conductive adjusting agent, a flowability improving agent, or a cleanability improving agent may be added to the binder resin in addition to the release agent and the colorant.

Non-limiting examples of the release agent are: an aliphatic hydrocarbon wax such as a low molecular weight polyethylene, a low molecular weight polypropylene, olefin copolymer, a microcrystalline wax, a paraffin wax, or a Fischer-Tropsch wax; an aliphatic hydrocarbon wax oxide such as a polyethylene wax oxide, or a block copolymer thereof; a wax containing an aliphatic ester such as a carnauba wax or a montanate wax as a main component; and a wax containing an aliphatic ester deacidified partially or totally such as a deacidified carnauba wax. It is preferable to add 0.1 to 20 weight parts (more preferably 0.5 to 12 weight parts) of the releasing agent to 100 weight parts of the binder resin. A plurality of kinds of waxes may be used in combination.

The colorant may contain, alone or in combination, a dye, a pigment or the like used as a colorant for a black, yellow, magenta or cyan toner. Non-limiting examples of the colorant are: carbon black, iron oxide, phthalocyanine blue, permanent brown FG, brilliant fast scarlet, pigment green B, rhodamine-B base, solvent red 49, solvent red 146, pigment blue 15:3, solvent blue 35, quinacridone, carmine 6B, disazoyellow and the like. It is preferable to add 2 to 25 weight parts (more preferably 2 to 15 weight parts) of the colorant to 100 weight parts of the binder resin.

Conventional charge controlling agent may be used. For example, an azo complex charge control agent, a salicylic acid charge control agent or a calixarene charge control agent may be used for a negatively chargeable toner. It is preferable to add 0.05 to 15 weight parts (more preferably, 0.1 to 10 weight parts) of the charge controlling agent to 100 weight parts of the binder resin.

The binder resin, the release agent, the colorant and the charge control agent are mixed using a Henschel mixer. The resulting material is molten and kneaded using a twin-screw extruder. The resulting material is cooled, cracked using a cutter mill, and crushed using a crusher with an impact plate. The resulting material is classified using an air classifier, so that toner mother particles having a mean particle diameter of a predetermined range are obtained.

Next, 0.01 to 10 weight parts (more preferably, 0.05 to 8 weight parts) of silica as an external additive is added to 1 kg (100 weight parts) of the toner mother particles, and is mixed using the Henschel mixer. With such processes, the toner is obtained.

The external additive is added for the purpose of enhancing environmental stability, charge stability, developing performance, flowability and preservability. Here, the external additive is famed of silica (SiO₂).

In this embodiment, a plurality of silica particles (i.e., a plurality of kinds of external additives) having different mean particle diameters are used. To be more specific, hydrophobic silica P1 (i.e., a first external additive) having a mean particle diameter of 16 nm, hydrophobic silica P2 (i.e., a second external additive) having a mean particle diameter of 25 nm, hydrophobic silica P3 (i.e., a third external additive) having a mean particle diameter of 40 nm, and colloidal silica P4 (i.e., a fourth external additive) having a mean particle diameter of 100 nm are used. The hydrophobic silica P1, P2 and P3 are manufactured by Nippon Aerosil Co., Ltd., and the colloidal silica P4 is manufactured by Shin-Etsu Chemical Co., Ltd.

The hydrophobic silica P1-P3 and the colloidal silica P4 are collectively referred to as silica P1-P4. A total amount of the silica P1-P4 contained in the toner is measured based on an amount (weight %) of Si (silicon) contained in the toner. The amount of Si contained in the toner is measured using an energy dispersion type X-ray analyzer described later.

The mean particle diameter (i.e., a volume mean particle diameter) of the toner of this embodiment is in a range from 5 μm to 7 μm. The mean particle diameter of the toner is measured using “Multisizer II” manufactured by Beckman Coulter Inc. In this regard, the mean particle diameter of the toner is substantially the same as a mean particle diameter of the toner mother particles.

A circularity of the toner is in a range from 0.955 to 0.970. The circularity of the toner is measured using “Flow Particle Image Analyzer FPIA 3000” manufactured by Sysmex Corp. The circularity of the toner is calculated according to the following equation:

Circularity=L1/L2

where L1 represents a perimeter of a circle having the same area as a projected image of the particle (i.e., the toner), and L2 represents a perimeter of the projected image of the particle. A measured value of the circularity is obtained by dividing a sum of circularities of all measured particles by the number of the measured particles.

The toner used in this embodiment is of a negatively chargeable type. A saturated charge amount of the toner is in a range from −10 μC/g to −5 μC/g. In order to measure the saturated charge amount of the toner, 4 weight % of the toner and 96 weight % of silicone coated ferrite carrier (manufactured by Kanto Denka Kogyo Co., Ltd.) are mixed in a ball mill for 1 minute. Then, the saturated charge amount of the toner is measured using a suction type portable charge amount meter “Q/M Meter Model 210HS” manufactured by Trek Inc.

All of the toners (i.e., samples 1-11 described later) of the embodiment have the same thermophysical properties, since they contain the same toner mother particles. A glass transition point TG of the toner is 55° C. in differential scanning calorimetric measurement using a differential scanning calorimeter “EXSTAR 600” (manufactured by Seiko Instruments Inc.). In this regard, a glass transition point TG of a normal toner (which is not a low melt toner) is generally higher than or equal to 60° C.

In the differential scanning calorimetric measurement, a weak endothermic peak is observed in a range between 30° C. to 70° C. in a first temperature rising process (i.e., first melting of the toner). No endothermic peak is observed in the range between 30° C. to 70° C. in a second temperature rising process (i.e., second melting of the toner after cooling). The reason why the endothermic peak is observed in the first temperature rising process and is not observed in the second temperature rising process is that the toner contains crystalline polyester resin as the binder resin.

### <Operation of Image Forming Apparatus>

Next, an operation of the image forming apparatus (i.e., an image forming operation) of the embodiment will be described. The printer controller 40 receives a print command and print data from the host device 35, and starts an image forming operation. First, the conveyance controller 53 causes the hopping roller 17 to rotate to feed the recording medium P one by one from the medium cassette 16 into the conveyance path 30. Further, the registration roller 18 rotates to convey the recording medium P toward the secondary transfer portion.

In each process unit 2, the photosensitive drum 3 rotates under control of the motor driver 47. The charging roller 4 rotates following the rotation of the photosensitive drum 3. The developing roller 5 and the supplying roller 6 are driven to rotate by a rotation force transmitted from the photosensitive drum 3 via gears. Further, the belt driving roller 14 rotates to move the intermediate transfer belt 13 under control of the belt drive controller 52.

In each process unit 2, the charging voltage of −1000V is applied to the charging roller 4 under control of the power controller 48, and the surface of the photosensitive drum 3 is uniformly charged to −500V. The LED head 11 emits light to expose the surface of the photosensitive drum 3 based on image data of each color under control of the exposure controller 49. An electrostatic latent image of −50V is formed on the surface of the photosensitive drum 3 according to image data.

The supplying roller 6 is applied with the supplying voltage of −230V under control of the power controller 48, and supplies the toner to the developing roller 5. The toner held on the surface of the developing roller 5 is charged to −25 μC/g by friction with the regulation blade 7 and the like, and a toner thin layer is formed on the surface of the developing roller 5. The developing roller 5 is applied with the developing voltage of −150V, and causes the toner to adhere to the electrostatic latent image on the surface of the photosensitive drum 3 (i.e., develops the electrostatic latent image).

When the toner image (i.e., a developer image) on the photosensitive drum 3 reaches a primary transfer nip, the primary transfer voltage of +1500V is applied to the primary transfer roller 12. With the primary transfer voltage, the toner image is transferred (i.e., primarily transferred) from the photosensitive drum 3 to a surface of the intermediate transfer belt 13. By the rotation of the intermediate transfer belt 13, the toner image moves to reach the secondary transfer portion (i.e., the secondary transfer backup roller 21 and the secondary transfer roller 22). This timing coincides with timing at which a leading end of the recording medium P conveyed from the registration roller 18 reaches the secondary transfer portion.

When the toner image on the intermediate transfer belt 13 and the recording medium P reach the secondary transfer portion, the secondary transfer voltage of +2000V is applied to the secondary transfer roller 22, and the toner image is transferred (i.e., secondarily transferred) from the intermediate transfer belt 13 to the recording medium P. The toner that remains on the surface of the intermediate transfer belt 13 after secondary transfer is scraped off by the intermediate transfer belt cleaning member 33, and is recovered by the waste toner recovery section 34.

The recording medium P to which the toner image is transferred in the secondary transfer portion is further conveyed to the fixing device 23. The toner adhering to the recording medium P (by electrostatic force) is molten and fixed to the recording medium P by being heated and pressed by the heat roller 24 and the pressure roller 25. The recording medium P with the fixed toner image is conveyed by the conveying roller pairs 27, 28 and 29, and is ejected outside the image forming apparatus 1. The ejected recording medium P is placed on the stacker portion 32.

Although the negatively chargeable toner is used in this embodiment, it is also possible to use a positively chargeable toner. In such a case, the charging roller 4 and the developing roller 5 are applied with positive voltages, and the primary transfer rollers 12 are applied with negative voltages.

Further, although the image forming apparatus 1 of the embodiment employs an intermediate transfer method that transfers a toner image to the recording medium P via the intermediate transfer belt 13, it is also possible to employ a direct transfer method that directly transfers a toner image from the photosensitive drum 3 to the recording medium P. When the direct transfer method is employed, the recording medium P corresponds to the transfer body that receives a toner image transferred from the photosensitive drum 3 as an image bearing body (see FIG. 2).

### <Periodic Residual Image>

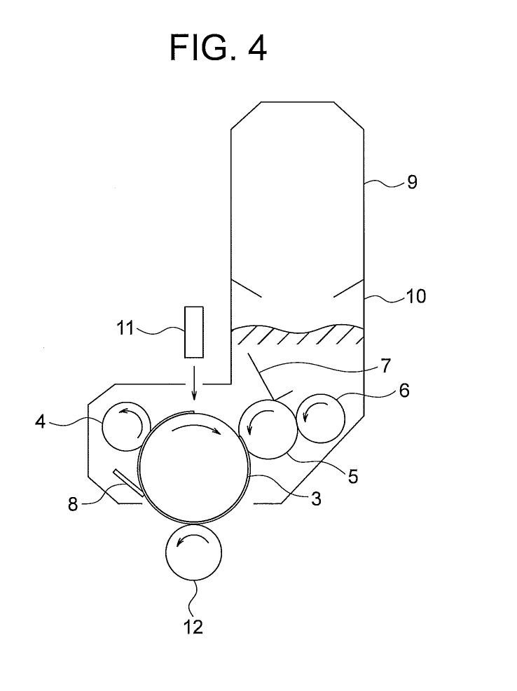

In the above described image forming operation, the external additive may separate from the toner (to be more specific, toner mother particles). The external additive separated from the toner may move to the photosensitive drum 3 from the developing roller 5. In such a case, if the external additive adhering to the photosensitive drum 3 passes through the cleaning blade 8 as shown in FIG. 4, the external additive may reach a portion exposed with light emitted by the LED head 11, and may block light emitted from the LED head 11. Particularly, when printing is performed so that an image portion (i.e., a portion to which the toner is transferred) and a non-image portion (i.e., a portion to which no toner is transferred) are adjacent to each other, the external additive may affect images printed subsequently.

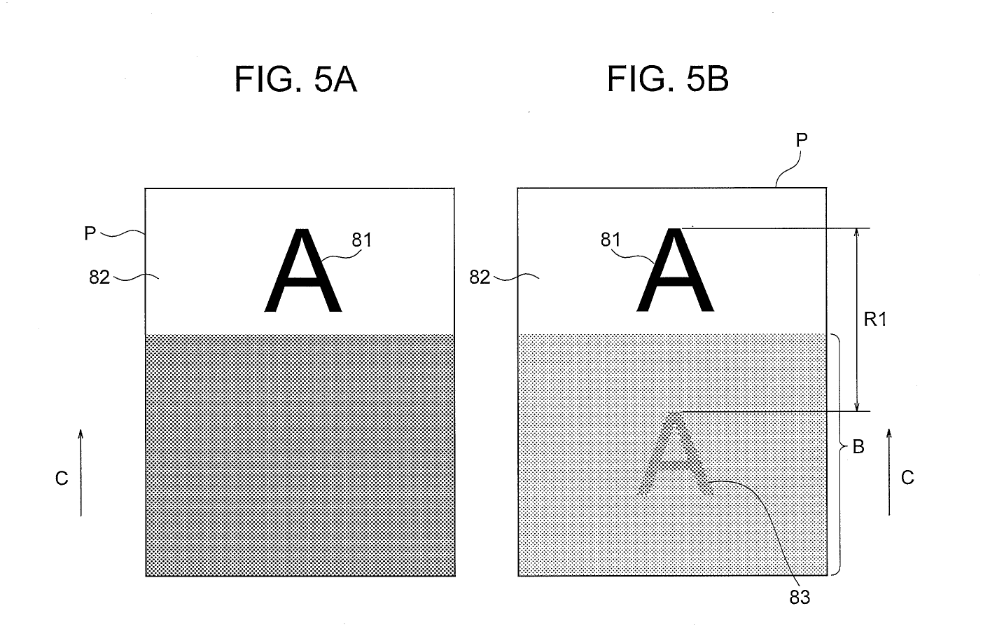

FIG. 5A is a schematic view showing an example of a printed image in which a thick character “A” (referred to as a character portion 81) is printed in an upper area of a printing surface on the recording medium P. A blank portion 82 is provided around the character portion 81. A halftone image is printed in an area B (lower than the upper area) of the printing surface of the recording medium P. The conveying direction of the recording medium P is shown by an arrow C. An upper part of the printing surface is a leading end side of the recording medium P in the conveying direction, and a lower part of the printing surface is a trailing end side of the recording medium P in the conveying direction.

Regarding the character portion 81 of “A” (i.e., a solid pattern), even when the external additive separated from the toner exists, such external additive is transferred to the recording medium P together with the toner. Therefore, the external additive does not remain on the photosensitive drum 3, and does not block the light from the LED head 11.

In contrast, regarding the blank portion 82, the toner does not move to the photosensitive drum 3, but the external additive separated from the toner moves to the photosensitive drum 3. Such external additive passes through the cleaning blade 8, and reaches the portion exposed with light emitted by the LED head 11. A contrast between a portion where the external additive exists (i.e., the blank portion 82) and a portion where the external additive does not exist (i.e., the character portion 81) appear on an image printed subsequently.

FIG. 5B is a schematic view showing the printed image of FIG. 5A when separation of the external additive from the toner occurs. In the area B shown in FIG. 5B, a density of the halftone image decreases. This is caused by the external additive on the photosensitive drum 3 blocking the light from the LED head 11. A residual image 83 (i.e., an afterimage) in the form of a character “A” appears below the character portion 81 at a distance R1 corresponding to a circumference (i.e., one round) of the photosensitive drum 3. That is, an interval (i.e., a period) between an original image and the residual image 83 on the printing surface of the recording medium P corresponds to the circumference of the photosensitive drum 3. The residual image is also referred to a periodic residual image (or a photosensitive body periodic residual image).

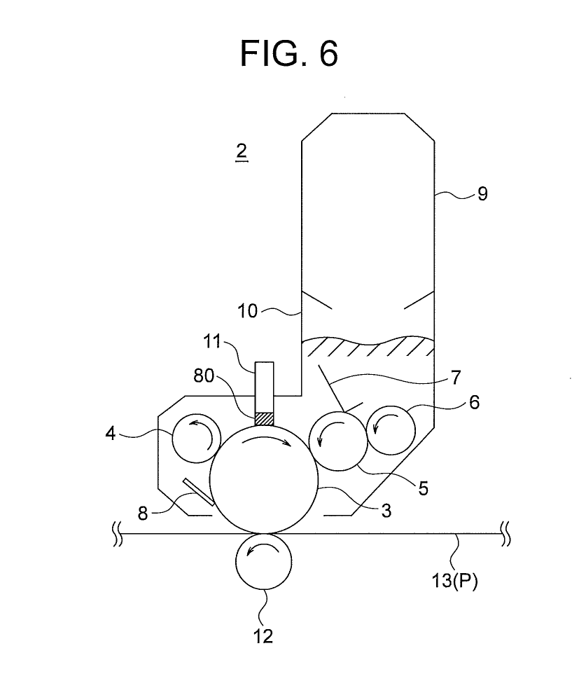

FIG. 6 is a schematic view showing a measuring method of an amount of the external additive adhering to the surface of the photosensitive drum 3. A collection member 80 formed of a high density sponge rubber is inserted between the photosensitive drum 3 and the LED head 11, and is brought into contact with the surface of the photosensitive drum 3 as shown in FIG. 6. The collection member 80 is disposed perpendicularly to the surface of the photosensitive drum 3. The collection member 80 dams the external additive so as not to allow the external additive to pass. In this state, the photosensitive drum 3 is driven to rotate one turn, and an amount of the external additive collected by the collection member 80 is measured.

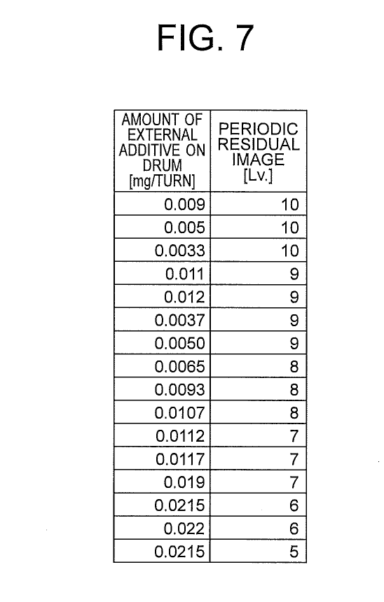

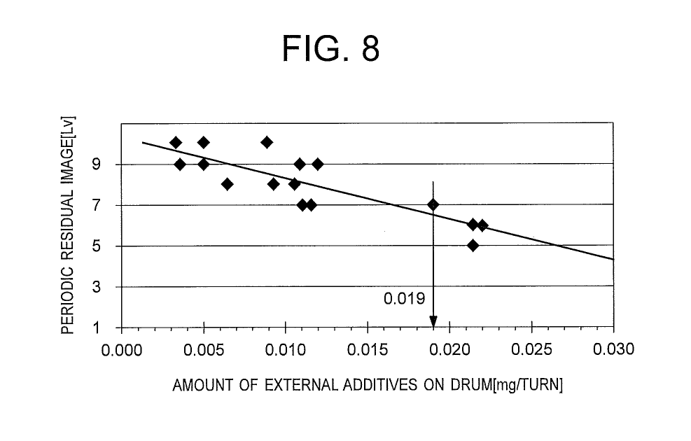

FIG. 7 is a table showing the amount of the external additive (collected using the collection member 80 while rotating the photosensitive drum 3 one turn) and an evaluation result of a periodic residual image. FIG. 8 is a graph showing the result of FIG. 7. In this regard, the amount of the external additive collected using the collection member 80 while rotating the photosensitive drum 3 one turn (hereinafter referred to as an amount of the external additive on the photosensitive drum 3) is regarded as an amount of the toner that adheres to the photosensitive drum 3 and is not removed by the cleaning blade 8 while the photosensitive drum 3 rotates one turn.

The periodic residual image is checked with visual inspection, and is rated on a scale of 1 to 10 (i.e., levels 1 to 10) according to a density of the residual image. The level 10 is a level at which no periodic residual image is visually observed. The level 1 is a level at which a periodic residual image is clearly visually observed. The levels 7-9 are levels at which a practically acceptable periodic residual image (i.e., not noticeable by an operator in office use) is observed.

As shown in FIG. 8, the amount of external additive on the photosensitive drum 3 has a negative correlation with the evaluation result of the periodic residual image. That is, as the amount of the external additive on the photosensitive drum 3 decreases, the periodic residual image becomes less likely to occur (i.e., the level becomes higher). Further, as shown in FIG. 8, when the amount of the external additive on the photosensitive drum 3 is less than or equal to 0.0019 mg, the evaluation result of the periodic residual image is higher than or equal to the level 7, i.e., a noticeable periodic residual image does not occur.

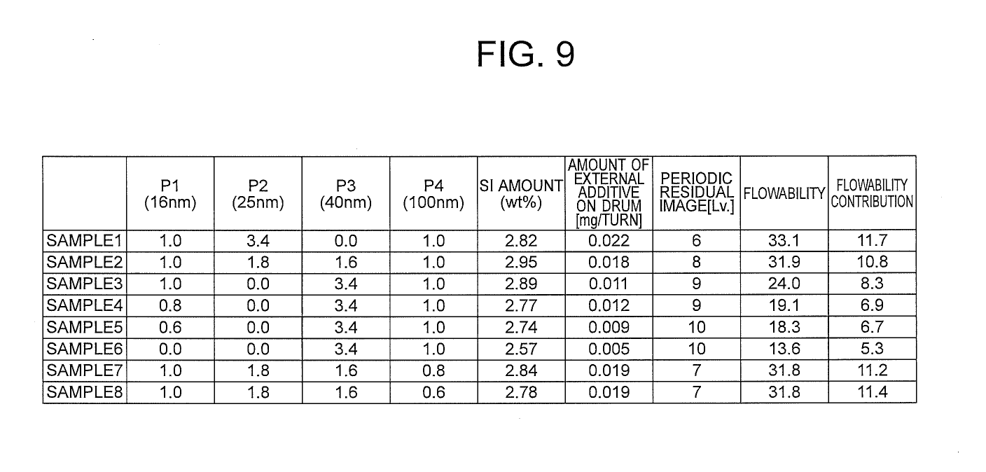

Next, relationship between a ratio of silica as the external additive and the periodic residual image will be described. FIG. 9 is a table showing the amounts of silica P1-P4 contained in the toner, the amount of Si contained in the toner, the amount of the external additive on the photosensitive drum 3 and the evaluation result of the periodic residual image.

Samples 1-8 of the toner are formed while changing a ratio (i.e., weight ratio) of the silica P1, P2, P3 and P4. Values in columns of the silica P1, P2, P3 and P4 in FIG. 9 represent the ratio (i.e., weight ratio) of the silica P1, P2, P3 and P4. The samples 1-8 are common except for the amounts of the silica P1, P2, P3 and P4. The composition of the toner mother particles is as described above.

In sample 1, the hydrophobic silica P1 (having a mean particle diameter of 16 nm), the hydrophobic silica P2 (having mean particle diameter of 25 nm), the hydrophobic silica P3 (having a mean particle diameter of 40 nm), and the colloidal silica P4 (having a mean particle diameter of 100 nm) are in the ratio 1.0:3.4:0.0:1.0 The silica P1, P2, P3 and P4 in sample 2 are in the ratio 1.0:1.8:1.6:1.0

The silica P1, P2, P3 and P4 in sample 3 are in the ratio 1.0:0.0:3.4:1.0

The silica P1, P2, P3 and P4 in sample 4 are in the ratio 0.8:0.0:3.4:1.0

The silica P1, P2, P3 and P4 in sample 5 are in the ratio 0.6:0.0:3.4:1.0

The silica P1, P2, P3 and P4 in sample 6 are in the ratio 0.0:0.0:3.4:1.0 The silica P1, P2, P3 and P4 in sample 7 are in the ratio 1.0:1.8:1.6:0.8

The silica P1, P2, P3 and P4 in sample 8 are in the ratio 1.0:1.8:1.6:0.6

The “Si amount (weight %)” in FIG. 9 indicates an amount of Si (silicon) contained in the toner. The amount of Si represents the weight ratio (weight %) of a sum of the silica P1, P2, P3 and P4 to the toner mother particles. The amount of Si is measured using an energy dispersion type X-ray analyzer (i.e., an energy dispersion type fluorescent X-ray analyzer “EDX-800HS” manufactured Shimadzu Corporation).

The results of the samples 1-3 in FIG. 9 indicate that, as the ratio of the silica P2 decreases and the ratio of the silica P3 increases, the amount of the external additive on the photosensitive drum 3 decreases and the level of the periodic residual image is improved. No correlation is found between the amount of Si and the level of the periodic residual image.

This indicates that the amount of the external additive on the photosensitive drum 3 and the periodic residual image are greatly influenced by a range of the particle diameters of the external additive rather than the total amount of the external additive (i.e., the sum of the silica P1-P4) contained in the toner. This means that the external additive having a small particle diameter is likely to pass through the cleaning blade 8 and is difficult to remove. It is understood that the periodic residual image can be suppressed by using the external additive having a large particle diameter without using the external additive having a small particle diameter.

The results of the samples 3-6 indicate that, as the ratio of the smallest silica P1 decreases, the level of the periodic residual image is improved. In the samples 7 and 8, the ratio of the largest silica P4 decreases, but the level of the periodic residual image is not improved.

FIG. 9 also shows a measurement result of a flowability of the toner. The flowability of the toner is determined based on a cohesive degree of the toner. The cohesive degree of the toner is measured using a multi-functional powder property measuring apparatus “multi-tester MT-1001” (manufactured by Seishin Enterprise Co., Ltd.). The cohesive degree (dimensionless value) of the toner is measured at an environmental temperature of 24° C. and a relative humidity of 40% and using three sieves having openings of 250 μm, 150 μm and 75 μm vibrated at an amplitude of 1.0 mm. The flowability is obtained using the following equation:

Flowability=100−Cohesive Degree

The result shown in FIG. 9 indicates that, as the ratio of the larger external additive (i.e., the silica P3 and P4) increases, the flowability of the toner decreases. This is because, as the silica becomes smaller on the assumption that the amount of Si is the same, the ratio of the silica covering the surface of the toner increases and surface-to-surface contact between the toners is reduced.

Here, a flowability contribution K is a contribution of the amount of Si (i.e., the amount of the external additive contained in the toner) to the flowability of the toner. The flowability contribution K is defined as follows:

$$Flowability Contribution K = \frac{Flowability}{Si Amount}$$

The flowability contribution K represents a flowability per the amount (weight %) of Si. That is, as the amount of the smaller silica is larger, the flowability contribution K becomes higher. As the amount of the larger silica is larger, the flowability contribution K becomes lower. Therefore, using the flowability contribution K, a ratio of the larger external additive to the smaller external additive is generally grasped. The flowability contribution K is also shown in FIG. 9.

As shown in FIG. 9, there is a negative correlation between the evaluation result of the periodic residual image (level) and the flowability contribution. That is, as the flowability contribution becomes higher, the periodic residual image is less likely to occur (i.e., the evaluation result becomes higher). As the flowability contribution becomes lower, the periodic residual image is more likely to occur (i.e., the evaluation result becomes lower).

There is a correlation between the periodic residual image and the flowability to some extent. However, the sample 2 and the sample 7 are substantially the same in the flowability, but different in the flowability contribution. Therefore, the correlation between the periodic residual image and the flowability contribution is higher than the correlation between the periodic residual image and the flowability.

The result shown in FIG. 9 indicates that, when the flowability contribution is higher than 11.4 (i.e., the sample 1), the amount of the external additive on the photosensitive drum 3 is greater than 0.019 mg, and the evaluation result of the periodic residual image is lower than level 7 (i.e., a practically unsatisfactory level).

In contrast, when the flowability contribution is lower than or equal to 11.4 (i.e., the samples 2-8), the amount of the external additive on the photosensitive drum 3 is less than or equal to 0.019 mg, and the evaluation result of the periodic residual image is higher than or equal to 7 (i.e., a practically satisfactory level). From this result, it is understood that the periodic residual image can be suppressed when the flowability contribution is lower than or equal to 11.4.

In this regard, if the flowability contribution is too low (i.e., if the particle diameter of the external additive is too large), a smear phenomenon occurs due to a decrease in the flowability. The smear phenomenon is caused when the toner on the developing roller 5 is excessively charged or when the toner layer on the developing roller 5 becomes excessively thick and an electric charge increases. In such a case, an electric potential of the toner on the developing roller 5 becomes higher than a surface electric potential of a non-exposed portion of the photosensitive drum 3. As a result, the toner adheres to the non-exposed portion, and a smear appears on the blank portion of the recording medium P.

An evaluation of the smear is performed by printing a test pattern at a duty of 0.3% (i.e., thin horizontal lines) using the image forming apparatus 1 shown in FIG. 1. In this regard, the term “duty” refers to a ratio of a printed area to a total printable area. When a solid pattern is printed on the whole printable area of a recording medium, the duty is 100%. When printing is performed on 1% of the printable area of the recording medium, the duty is 1%. A printing sheet (i.e., a normal paper) of A4 size is used as the recording medium P. Printing is performed under an office environment (at a temperature of 24° C. and a relative humidity of 50%), a high-temperature and high-humidity environment (at a temperature of 28° C. and a relative humidity of 80%), a low-temperature and low-humidity environment (at a temperature of 10° C. and a relative humidity of 20%). Printing is performed on 2500 printing sheets for each environment for two days, and a smear on the blank portion of the recording medium P is visually inspected.

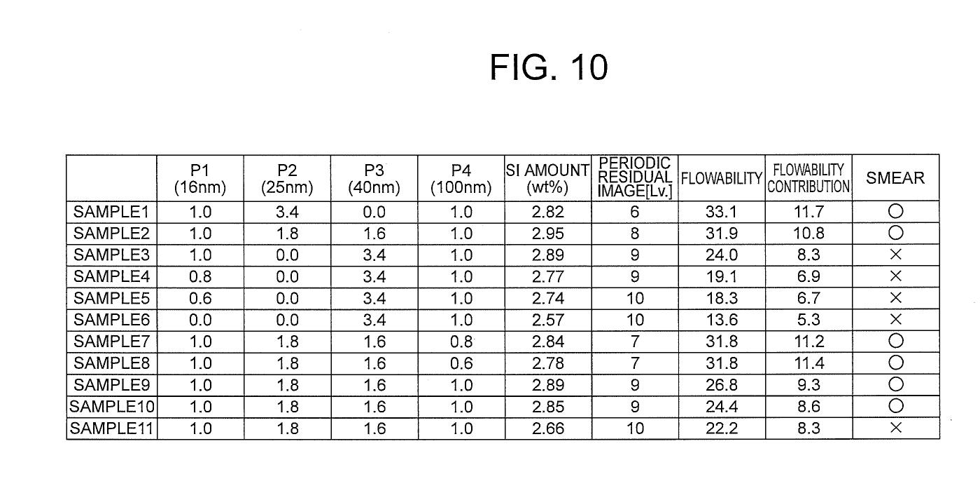

FIG. 10 is a table showing the amounts of the silica P1-P4 contained in the toner, the amount of Si contained in the toner, the evaluation result of the periodic residual image, the flowability, the flowability contribution and the evaluation result of the smear.

The evaluation of the smear is performed by preparing samples 9-11 in addition to the samples 1-8 shown in FIG. 9. In each of the samples 9-11, the silica P1, P2, P3 and P4 are in the ratio 1.0:1.8:1.6:1.0 (i.e., which is the same as in sample 2). The amount of Si in the sample 9 is 2.89, the amount of Si in the sample 10 is 2.85, and the amount of Si in the sample 11 is 2.66. That is, the samples 9-11 are the same in the ratio of silica P1-P4, and different in the total amount of the silica P1-P4.

The result shown in FIG. 10 indicates that, as the flowability contribution decreases, the flowability also decreases, and the smear phenomenon is more likely to occur. The smear is found in the samples 3-6 and 11 in which the flowability contribution is lower than 8.6. From this result, it is understood that the smear phenomenon can be suppressed when the flowability contribution is higher than or equal to 8.6.

From the above described results, it is understood that the occurrence of the periodic residual image and the smear phenomenon can be suppressed when the flowability contribution is in a range from 8.6 to 11.4.

Here, the toner containing crystalline polyester resin and amorphous polyester resin as the binder resin has been described. However, the toner may contain another resin in addition to crystalline polyester resin and amorphous polyester resin.

Further, although the toner formed by the pulverizing method has been described, a toner (i.e., a polymerization toner) formed by a suspension polymerization method may also be used.

### Effects of Embodiment

As described above, according to the embodiment of the present invention, the toner (i.e., developer) includes toner mother particles containing crystalline polyester resin as a binder resin, a plurality of kinds of external additives (silica) having different particle diameters. A value (i.e., the flowability contribution K) obtained by dividing the flowability of the toner by the amount (weight %) of silica contained in the toner is in a range from 8.6 to 11.4. The amount of silica is measured by the energy dispersion type X-ray analyzer. With such a configuration, the occurrence of the periodic residual image and the smear phenomenon can be suppressed. Therefore, an image of high quality can be formed even when a low melt toner is used.

Further, since the toner is a low melt toner (i.e., a low melt developer) having a glass transition temperature lower than or equal to 60° C., a fixing temperature can be lowered to about 150-160° C., and therefore energy consumption of the image forming apparatus 1 can be reduced.

Further, as the binder resin of the toner contains amorphous polyester resin in addition to crystalline polyester resin, durability and preservability of the low melt toner can be enhanced.

The image forming apparatus of the present invention is not limited to a printer, but is applicable to a copier, a facsimile machine, an MFT (Multi-Function Peripheral), a label producing machine, and the like.

While the preferred embodiments of the present invention have been illustrated in detail, it should be apparent that modifications and improvements may be made to the invention without departing from the spirit and scope of the invention as described in the following claims.

What is claimed is:

1. An image forming apparatus comprising:
a developer;
an image bearing body;
a charging member that charges a surface of the image bearing body;
an exposure device that emits light to expose the surface of the image bearing body to form a latent image;
a developer bearing body that bears the developer and develops the latent image to form a developer image; and
a transfer portion that transfers the developer image from the image bearing body to a transfer body,
wherein the developer comprises:
mother particles containing crystalline polyester resin as a binder resin, and
a plurality of kinds of external additives containing silica and having different particle diameters,
wherein a value obtained by dividing a flowability of the developer by a weight percent of silica contained in the developer is in a range from 8.6 to 11.4, the weight percent of silica being measured by an energy dispersion type X-ray analyzer.

2. The image forming apparatus according to claim 1, wherein the developer is formed by a pulverization method.

3. The image forming apparatus according to claim 1, wherein in a differential scanning calorimetry (DSC), the developer shows an endothermic peak in a temperature range from 30° C. to 70° C. in a first temperature rising process, and does not show an endothermic peak in the temperature range from 30° C. to 70° C. in a second temperature rising process.

4. The image forming apparatus according to claim 1, wherein a degree of circularity of the developer is in a range from 0.955 to 0.970.

5. The image forming apparatus according to claim 1, wherein a saturated charge amount of the developer is in a range from −10 μC/g to −50 μC/g.

6. The image forming apparatus according to claim 1, wherein the developer has no carrier.

7. The image forming apparatus according to claim 1, wherein a glass transition temperature of the developer is lower than or equal to 60° C.

8. The image forming apparatus according to claim 1, wherein the flowability is determined based on a cohesive degree of the developer.

9. The image forming apparatus according to claim 1, wherein the developer contains non-crystalline polyester in addition to crystalline polyester as the binder resin.

10. The image forming apparatus according to claim 1, wherein the transfer body is an intermediate transfer belt.

11. The image forming apparatus according to claim 1, wherein the transfer body is a recording medium.

12. A developing device comprising:
a developer, and
a developer bearing body that bears the developer and develops a latent image famed on an image bearing body,
wherein the developer comprises:
mother particles containing crystalline polyester resin as a binder resin, and
a plurality of kinds of external additives containing silica and having different particle diameters,
wherein a value obtained by dividing a flowability of the developer by a weight percent of silica contained in the developer is in a range from 8.6 to 11.4, the weight percent of silica being measured by an energy dispersion type X-ray analyzer.
